(19) United States
(12) Patent Application Publication
(10) Pub. No.: US 2026/0118699 A1
(43) Pub. Date: Apr. 30, 2026

(54) GLASSES AND AUGMENTED REALITY DEVICE

(71) Applicant: GOERTEK INC., Weifang (CN)

(72) Inventors: Haijun YIN, Weifang (CN); Yaocheng LIU, Weifang (CN)

(21) Appl. No.: 19/433,393

(22) Filed: Dec. 26, 2025

Related U.S. Application Data
(63) Continuation of application No. PCT/CN2024/137000, filed on Dec. 5, 2024.

(30) Foreign Application Priority Data
May 31, 2024 (CN) 202410705974.3

(51) Int. Cl. G02C 5/22

(52) U.S. Cl. CPC G02C 5/2254; G02C 5/2263

(57) ABSTRACT

The present application provides glasses and an AR device. The glasses include a frame, temples, and a hinge structure. One end of the rotating base of the hinge structure is movably accommodated in an installation groove in the frame. One end of the first connecting member is rotatably connected to the rotating base via the first rotating shaft matching with the rotating shaft of the first rotating hole. The other end of the first connecting member is connected to the temples. A first elastic member has a damping groove rotatably abutted against the first rotating shaft. A second rotating shaft of a second connecting member is rotatably inserted through a first through hole and a second rotating hole, thereby rotatably connecting the rotating base to the frame. A sliding shaft is movably inserted through the second through hole and the sliding hole.

### CROSS-REFERENCE TO RELATED APPLICATIONS

The present application is a continuation application of International Application No. PCT/CN2024/137000, filed on Dec. 5, 2024, which claims priority to Chinese Patent Application No. 202410705974.3, entitled in “GLASSES AND AUGMENTED REALITY DEVICE” and filed on May 31, 2024. The disclosures of the above-mentioned applications are incorporated herein by reference in their entireties.

### TECHNICAL FIELD

The present application relates to the technical field of glasses, and in particular to glasses and an augmented reality (AR) device using the glasses.

### BACKGROUND

Currently, glasses typically use a single shaft rotation for folding the temples for easy storage. However, due to differences in head size, single shaft glasses can cause discomfort and affect user experience. This is especially true for virtual reality (VR), augmented reality (AR), mixed reality (MR), and extended reality (XR) glasses, where they can even affect the clarity of binocular images.

In related technologies, some glasses feature a rotating shaft that allows for both temple folding and outward rotation to provide users with different head widths and improve comfort. However, for users with different head lengths, shapes, and nose-to-ear distances, these single shaft outward-rotating glasses still present discomfort.

### SUMMARY

The main purpose of the present application is to provide glasses and an AR device, aiming to provide a multi shaft rotating glasses with temples and frame capable of multi-degree-of-freedom rotational hinges to accommodate different head shapes and improve wearing comfort and versatility.

To achieve the above-mentioned purpose, the glasses provided by the present application include:
a frame provided with an installation groove and a first through hole and a second through hole communicating with the installation groove;
temples; and
a hinge structure including a rotating base, a first connecting member, a first elastic member, a second connecting member, and a second elastic member;
one end of the rotating base is movably accommodated in the installation groove, and the rotating base is provided with a receiving groove and a first rotating hole, a second rotating hole, and a sliding hole all communicating with the receiving groove;
the second rotating hole corresponds to the first through hole, and the sliding hole corresponds to the second through hole;
one end of the first connecting member is rotatably connected to the rotating base via a first rotating shaft engaging with a hole shaft of the first rotating hole, and the other end of the first connecting member is connected to the temple;
one end of the first elastic member is accommodated in the receiving groove and provided with a damping groove rotatably abutted against the first rotating shaft, and the other end of the first elastic member is elastically abutted against the first connecting member;
the second connecting member is provided with a second rotating shaft and a sliding shaft spaced apart;
the second rotating shaft rotatably passes through the first through hole and the second rotating hole sequentially, to make the rotating base rotatably connect to the frame;
the sliding shaft movably passes through the second through hole and the sliding hole;
the second elastic member is provided within the frame and elastically abutted against the rotating base; and
an axial direction of the first rotating shaft is at an angle to an axial direction of the second rotating shaft.

In an embodiment, the second elastic member is provided with multiple stop grooves, and an outer wall of the rotating base is provided with stop protrusions corresponding to the stop grooves; each stop protrusion is movably limited within each stop groove.

In an embodiment, the second elastic member includes a stop portion and two fixing portions connected to both ends of the stop portion; the stop portion is provided with a plurality of stop grooves, and a side wall of the installation groove is provided with an installation opening; the two fixing portions are connected to an outer side wall of the installation groove to make the stop portion correspond to the installation opening; and the stop protrusion passes through the installation opening and is movably limited within one of the stop grooves.

In an embodiment, the two fixing portions extend in opposite direction; or
the two fixing portions extend in a same direction as the stop portion; and/or
each fixing portion is connected to the outer side wall of the installation groove by a fastener; and/or
the plurality of stop grooves include a first stop groove, a second stop groove, and a third stop groove arranged sequentially adjacent to each other; the glasses have an initial position, a first position, and a second position, in the positions the rotating base driving the first connecting member and the temple to rotate relative to the frame about the second rotating shaft; in the initial position, the stop protrusion passes through the installation opening and is located in the second stop groove; in the first position, the stop protrusion passes through the installation opening and is located in the first stop groove; in the second position, the stop protrusion passes through the installation opening and is located in the third stop groove.

In an embodiment, the first elastic member includes a main body and a damping arm; one end of the main body is accommodated in the receiving groove, and the other end of the main body forms an outward-folding spring piece; the outward-folding spring piece is elastically abutted against the first connecting member, and the main body further includes an elastic through hole; one end of the damping arm is connected to an inner wall of the elastic through hole, and the other end of the damping arm extends along the elastic through hole and bends to form the damping groove.

In an embodiment, the first elastic member is made of stainless steel or carbon fiber, and the stainless steel includes one of titanium alloy, nickel-titanium alloy, and beryllium copper; and/or
an elastic modulus of the first elastic member is 50 GPa to 400 GPa; and/or
a length of the outward-folding spring piece is 5 mm to 30 mm; and/or
a thickness of the outward-folding spring piece is 0.3 mm to 1.5 mm; and/or
a distance from an end of the damping arm bent to form the damping groove to the damping arm is defined as an opening width of the damping groove, and the opening width is less than or equal to ⅓ of a circumference of the first rotating shaft; and/or
a fixing post protrudes from a bottom wall of the receiving groove; the fixing post is located between the first rotating hole and the second rotating hole, and the main body is fixed to the fixing post by fasteners; and/or
one of a groove wall of the receiving groove and the main body is provided with a locking protrusion, and the other one of the groove wall of the receiving groove and the main body is provided with a locking groove; the locking protrusion is limited within the locking groove.

In an embodiment, the rotating base includes a base plate and a side plate; the side plate is provided around a periphery of the base plate and encloses with the base plate to form the receiving groove; the side plate is provided with the first rotating hole, and the base plate is provided with the second rotating hole and the sliding hole;
the side plate is provided with a clearance notch communicating with the receiving groove adjacent to the first rotating hole; one end of the first elastic member away from the second rotating hole passes through the clearance notch and is elastically abutted against the first connecting member, and one side of the side plate facing away from the receiving groove is further provided with a stop protrusion; the stop protrusion is located at an end of the side plate away from the clearance notch, and the stop protrusion is elastically abutted against the second elastic member.

In an embodiment, a rotating cylinder protrudes from a bottom wall of the receiving groove around the second rotating hole, and the second rotating shaft sequentially rotatably passes through the first through hole and the second rotating hole, and is rotatably abutted against an inner wall of the rotating cylinder; and/or
a plurality of sliding holes are spaced apart around the second rotating hole; a plurality of second through holes are spaced apart around the first through hole; the sliding hole and the second through hole are arranged in a one-to-one correspondence; the second connecting member protrudes with a plurality of sliding shafts, and the plurality of sliding shafts are spaced apart around the second rotating shaft; each sliding shaft movably passes through each second through hole and each sliding hole; and/or
an axial direction of the second rotating hole is perpendicular to an axial direction of the first rotating hole; and/or
the axial direction of the second rotating hole is parallel to an axial direction of the sliding hole; and/or
the sliding hole is arc-shaped with a center of the second rotating hole as the center of the sliding hole; and/or
the second connecting member includes a connecting plate, and the second rotating shaft and the sliding shaft protruding from the connecting plate; the second rotating shaft is provided with a fixing hole, and the second connecting member further includes a fixing member; one end of the fixing member forms a limiting platform, and the second rotating shaft rotates sequentially through the first through hole and the second rotating hole, so that the frame is clamped between the connecting plate and the rotating base; one end of the fixing member is located in the fixing hole, so that the limiting platform is movably abutted against the rotating base.

In an embodiment, two first rotating holes are provided, and the two first rotating holes are coaxially arranged and located on opposite sides of the receiving groove;
the first connecting member includes a first connecting portion and two rotating arms provided at both ends of the first connecting portion, and the two rotating arms and the first connecting portion are enclosed to form a clearance groove; one end of each rotating arm away from the first connecting portion is provided with an installation hole, and the first connecting portion is connected to the temple; and
the first rotating shaft passes sequentially through the installation hole, the first rotating hole, and the damping groove, and both ends of the first rotating shaft are fixed in the two installation holes, so that a portion of the rotating base is accommodated in the clearance groove, and an end of the first elastic member away from the second rotating hole is elastically abutted against the first connecting portion.

In an embodiment, the first rotating shaft includes a rotating shaft portion and installation portions connected to both ends of the rotating shaft portion, and the rotating shaft portion sequentially passes through the first rotating hole and the damping groove; each installation portion is limited within an installation hole; the installation hole has at least one installation plane, and the installation portion has a limiting plane cooperating with the installation plane; and/or
the installation hole is a polygonal hole, and the first rotating hole is a circular hole; and/or
the first connecting portion is recessed to form a relief groove communicating with the clearance groove, and a support platform protruding from one side of the relief groove adjacent to the clearance groove; one end of the first elastic member away from the second rotating hole extends into the relief groove and is elastically supported by the support platform.

In an embodiment, the first connecting member further includes a limiting portion, and two ends of the limiting portion are respectively connected to the ends of the two rotating arms away from the first connecting portion; the limiting portion is located on a side of the first elastic member facing away from the receiving groove, and the first elastic member is provided with an outward-folding spring piece elastically abutted against the first connecting portion;
the glasses have: a folded state, an open state, and an outward-folding state; in the states, the first connecting member driving the temples to rotate relative to the rotating base and the frame around the first rotating shaft;
in the folded state, the temples are close to the frame; the first connecting portion is away from the first elastic member; and the limiting portion is close to the outward-folding spring piece;
in the open state, the temples are away from the frame and perpendicular to the frame; the first connecting portion is abutted against the outward-folding spring piece; and the limiting portion is away from the outward-folding spring piece; and
in the outward-folding state, the temples are at an obtuse angle to the frame; and the first connecting portion causes the outward-folding spring piece to deform.

In an embodiment, the glasses further include a protective plate and a housing; the protective plate is accommodated in the receiving groove and connected to a side of the first elastic member facing away from a bottom wall of the receiving groove; a side of the protective plate facing away from the first elastic member is provided with a wire-passing groove; the housing is provided to cover an opening of the receiving groove and cooperates with the wire-passing groove to form a wire-passing channel.

The present application also provides an augmented reality (AR) device, including: an optical system and the glasses, the optical system being connected to the frame of the glasses.

The glasses of the present application provide an installation groove on the frame, along with a first through hole and a second through hole communicating with the installation groove. This allows for convenient accommodation and positioning of the rotating base of the hinge structure via the installation groove. The rotating base has a receiving groove, a first rotating hole, a second rotating hole, and a sliding hole communicating with the receiving groove. The second rotating hole corresponds to the first through hole, and the sliding hole corresponds to the second through hole. One end of the first connecting member of the hinge structure is rotatably connected to the rotating base via a first rotating shaft engaging with the hole shaft of the first rotating hole. The other end of the first connecting member is connected to the temple. The second rotating shaft of the second connecting member of the hinge structure rotatably passes through the first through hole and the second rotating hole, while the sliding shaft movably passes through the second through hole and the sliding hole. This allows the temples and frame of the glasses to be rotatably connected via the first connecting member, the rotating base, and the second connecting member of the hinge structure. The axial direction of the first rotating shaft is angled to the axial direction of the second rotating shaft, allowing the temples to rotate relative to the rotating base and the frame via the first connecting member around the first rotating shaft, while the temples can also rotate relative to the frame via the rotating base around a second rotating shaft. This means the temples and frame can achieve multi-degree-of-freedom rotational hinges through a multi shaft hinge structure, making the glasses suitable for different head shapes, such as different head lengths, head shapes, and nose-ear distances, thus improving user comfort and versatility. Simultaneously, by placing one end of the first elastic member within a receiving groove and providing a damping groove on the first elastic member that abuts against the first rotating shaft, the other end of the first elastic member elastically abuts against the first connecting member. Thus, when the temples rotate relative to the rotating base and frame via the first connecting member around the first rotating shaft, the first elastic member provides damping for the temples'rotation. A second elastic member is placed within the frame and elastically abuts against the rotating base, providing elastic limiting and damping functions for the rotation of the rotating base relative to the frame, thereby offering different rotation angles.

### BRIEF DESCRIPTION OF THE DRAWINGS

In order to more clearly illustrate the embodiments of the present application or the technical solutions in the related art, the following briefly introduces the drawings required for use in the embodiments or the description of the related art. Obviously, the drawings described below are only some embodiments of the present application. For those skilled in the art, other drawings can be obtained based on the structures shown in these drawings without paying any creative work.

FIG. 1 is a structural schematic diagram of glasses according to an embodiment of the present application.

FIG. 2 is an exploded schematic diagram of the glasses according to an embodiment of the present application.

FIG. 3 is an enlarged schematic diagram of point A in FIG. 2.

FIG. 4 is a cross-sectional schematic diagram of the glasses along the axial direction of the second rotating shaft according to an embodiment of the present application.

FIG. 5 is a cross-sectional schematic diagram of the glasses along the axial direction of the first rotating shaft according to an embodiment of the present application.

FIG. 6 is a cross-sectional schematic diagram of the first position in FIG. 5.

FIG. 7 is a structural schematic diagram of the temples in the glasses rotating around the second rotating shaft according to an embodiment of the present application.

FIG. 8 is a structural schematic diagram of the temples in the glasses rotating around the first rotating shaft according to an embodiment of the present application.

FIG. 9 is an exploded diagram of the hinge structure in the glasses according to an embodiment of the present application.

FIG. 10 is an assembly structure diagram of the rotating base, the first elastic member, and the first connecting member in the glasses according to an embodiment of the present application.

FIG. 11 is a structural schematic diagram of the rotating base in the glasses according to an embodiment of the present application.

FIG. 12 is a structural schematic diagram of the first connecting member in the glasses according to an embodiment of the present application.

FIG. 13 is a structural schematic diagram of the first elastic member in the glasses according to an embodiment of the present application.

FIG. 14 is a structural schematic diagram of the second elastic member in the glasses according to an embodiment of the present application.

The purpose, functional features and advantages of the present application will be further explained in conjunction with the embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the embodiments described are only part of the embodiments of the present application, not all of the embodiments. Based on the embodiments of the present application, all other embodiments obtained by those skilled in the art without making creative efforts are within the protection scope of the present application.

It should be noted that all directional indications (such as up, down, left, right, front, back, etc.) in the embodiments of the present application are only used to explain the relative position relationship, movement status, etc. between the various components under a certain specific posture (as shown in the accompanying drawings). If the specific posture changes, the directional indication will also change accordingly.

Furthermore, the meaning of “and/or” throughout the text is that it includes three solutions. Taking “A and/or B” as an example, it includes solution A, or solution B, or a solution that simultaneously satisfies A and B.

In addition, descriptions involving “first”, “second” etc., in the present application are for descriptive purposes only and should not be construed as indicating or implying their relative importance or implicitly specifying the number of technical features indicated. Therefore, features defined as “first” and “second” can explicitly or implicitly include at least one of those features. Furthermore, the technical solutions of the various embodiments can be combined with each other, but only if they are feasible to those skilled in the art. If a combination of technical solutions is contradictory or impossible to implement, it should be considered that such a combination of technical solutions does not exist and is not within the protection scope claimed in the present application.

Currently, glasses typically use a single shaft rotation for folding the temples for easy storage. However, due to differences in head size, single shaft glasses can cause discomfort and affect user experience. This is especially true for virtual reality (VR), augmented reality (AR), mixed reality (MR), and extended reality (XR) glasses, where they can even affect the clarity of binocular images.

In related technologies, some glasses feature an rotating shaft that allows for both temple folding and outward rotation to accommodate users with different head widths and improve comfort. However, for users with different head lengths, shapes, and nose-to-ear distances, these single shaft outward-rotating glasses still present discomfort.

Based on the aforementioned concepts and problems, the present application proposes a pair of glasses 100. These glasses 100 not only allow for folding and storage of the temples 2 relative to the frame 1, normal wearing, and outward rotation, but also enable rotational adjustment of the temples 2 relative to the frame 1 in another direction. This allows the glasses 100 to be suitable for users with different head lengths, head shapes, and nose-to-ear distances, improving user comfort and versatility.

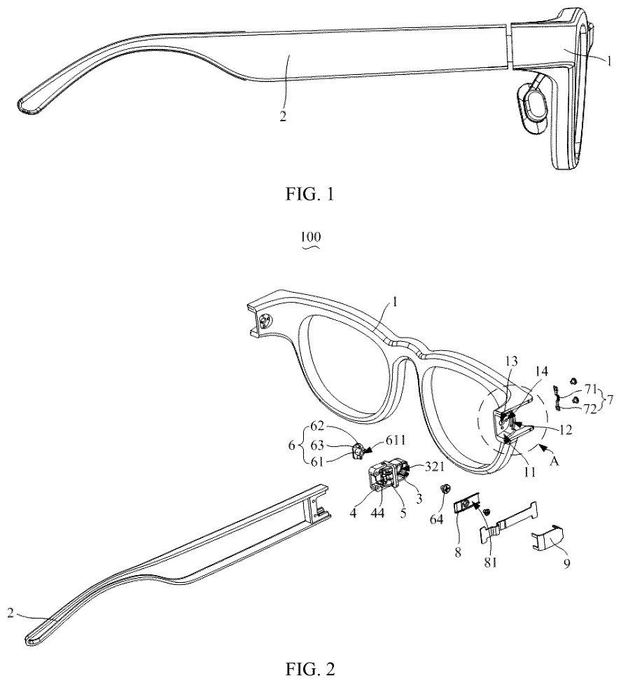

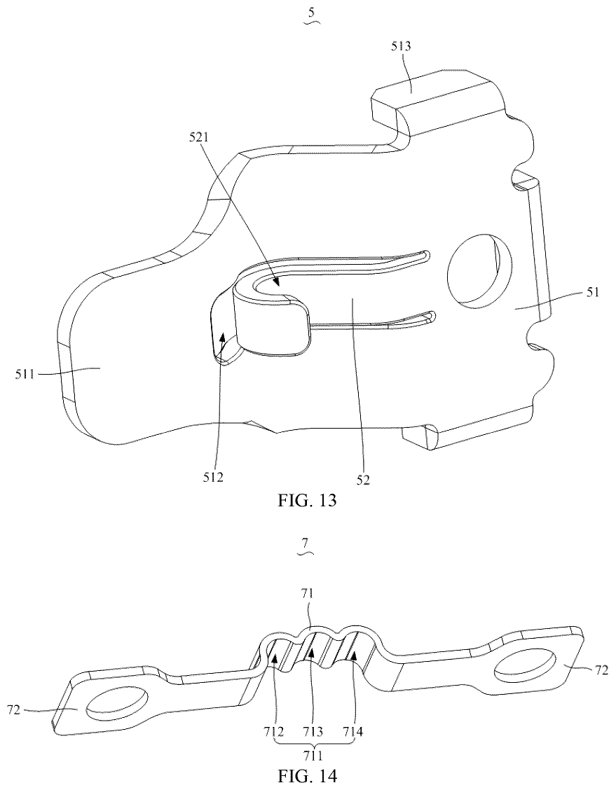

Referring to FIGS. 1 to 14, in this embodiment of the present application, the glasses 100 includes a frame 1, temples 2, and a hinge structure. The frame 1 has an installation groove 11 and a first through hole 13 and a second through hole 14 communicating with the installation groove 11. The hinge structure includes a rotating base 3, a first connecting member 4, a first elastic member 5, a second connecting member 6, and a second elastic member 7. One end of the rotating base 3 is movably accommodated in the installation groove 11, and the rotating base 3 has a receiving groove 31 and a first rotating hole 331, a second rotating hole 321, and a sliding hole 322 communicating with the receiving groove 31. The second rotating hole 321 corresponds to the first through hole 13, and the sliding hole 322 corresponds to the second through hole 14. One end of the first connecting member 4 is rotatably connected to the rotating base 3 via a first rotating shaft 44 matching with the hole shaft of the first rotating hole 331. The other end of the first connecting member 4 is connected to the temple 2. One end of the first elastic member 5 is accommodated in the receiving groove 31 and has a damping groove 521 that rotatably abuts against the first rotating shaft 44. The other end of the first elastic member 5 elastically abuts against the first connecting member 4. The second connecting member 6 has a second rotating shaft 61 and a sliding shaft 62 spaced apart. The second rotating shaft 61 rotatably passes through the first through hole 13 and the second rotating hole 321, allowing the rotating base 3 to be rotatably connected to the frame 1. The sliding shaft 62 movably passes through the second through hole 14 and the sliding hole 322. The second elastic member 7 is located inside the frame 1 and elastically abuts against the rotating base 3. The axial direction of the first rotating shaft 44 forms an angle with the axial direction of the second rotating shaft 61.

In this embodiment, the glasses 100 can be ordinary glasses such as myopia glasses, reading glasses, astigmatism glasses, sun protection glasses, and decorative glasses. The glasses 100 can also be smart glasses, such as virtual reality (VR), augmented reality (AR), mixed reality (MR), and extended reality (XR) glasses, etc., without limitation.

Understandably, the frame 1 of the glasses 100 has installation holes corresponding to the user's two eyes. These two installation holes can be used to mount different lenses or smart optical systems, etc., without limitation. For ease of wear, the frame 1 also has a nose pad structure between the two installation holes for contact with the user's nose bridge, etc., without limitation.

It should be noted that, for ease of wear, the frame 1 of the glasses 100 is typically rotatably connected to two symmetrically arranged temples 2, allowing the user to wear the glasses via the nose pads of the frame 1 and the two temples 2. Of course, in other embodiments, the frame 1 can also be connected to a headband structure to form a ring-shaped wearing space, especially for smart glasses devices. Because the optical system is mounted on the frame 1, the frame 1 is relatively heavy. To facilitate wearing and prevent the frame 1 from falling off due to its weight, a headband structure is designed, which is not limited here.

In this embodiment, the glasses 100 are described using the frame 1 and two temples 2 as an example. To facilitate the connection between the frame 1 and the two temples 2, connecting portions or installation portions are provided at both ends of the frame 1. It can be understood that the two connecting portions or installation portions at both ends of the frame 1 are set at a certain angle to the plane containing the two installation holes of the frame 1, that is, the two connecting portions or installation portions generally extend from both ends of the frame 1 towards the user's ears.

It should be noted that, to avoid the two connecting portions or installation portions at both ends of the frame 1 affecting the user's wearing experience, the extension length of the two connecting portions or installation portions is relatively short. The extension length of the two connecting portions or installation portions can refer to existing technology and is not limited here.

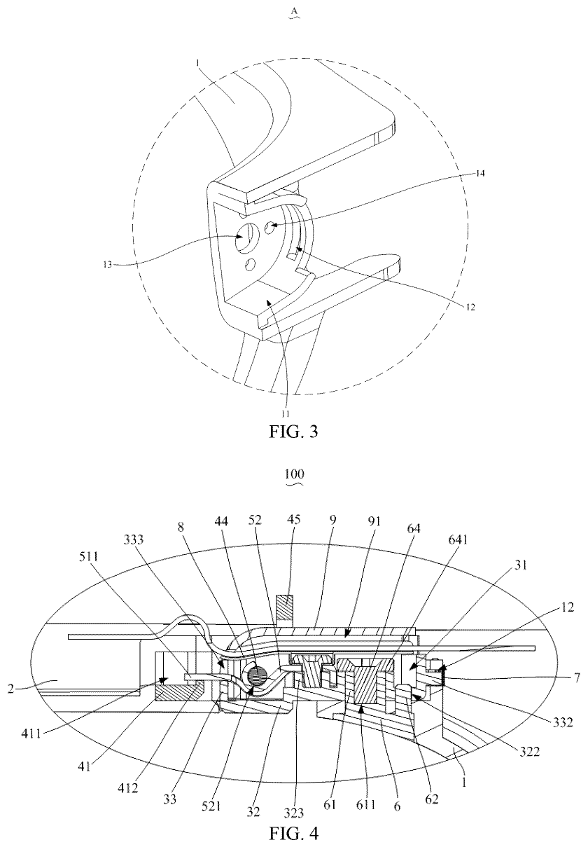

In this embodiment, as shown in FIGS. 2 and 3, the two connecting or installation portions at both ends of the frame 1 are respectively provided with installation grooves 11 and a first through hole 13 and a second through hole 14 communicating with the installation grooves 11. The installation grooves 11 are used to accommodate and install at least part of the hinge structure, and are connected to the temple 2 using the hinge structure, thus allowing the temple 2 to be rotatably connected to the connecting or installation portions at both ends of the frame 1 via the hinge structure.

It can be understood that by setting the hinge structure as a rotating base 3, a first connecting member 4, and a second connecting member 6, and by providing a receiving groove 31 and a first rotating hole 331, a second rotating hole 321, and a sliding hole 322 communicating with the receiving groove 31, one end of the first connecting member 4 is rotatably connected to the rotating base 3 via a first rotating shaft 44 engaging with the hole shaft of the first rotating hole 331, and the other end of the first connecting member 4 is connected to the temple 2; that is, the temple 2 is connected to the rotating base 3 to achieve a rotatable connection via the first connecting member 4 and the first rotating shaft 44. One end of the rotating base 3 is movably accommodated in the installation groove 11, so that the second rotating hole 321 corresponds to the first through hole 13, and the sliding hole 322 corresponds to the second through hole 14. Thus, the second rotating shaft 61 of the second connecting member 6 rotatably passes through the first through hole 13 and the second rotating hole 321 in sequence, and the sliding shaft 62 movably passes through the second through hole 14 and the sliding hole 322, so that the rotating base 3 is rotatably connected to the frame 1, thereby achieving a rotatable connection between the temple 2 and the frame 1 via a hinge structure.

It should be noted that because the axial direction of the first rotating shaft 44 is set at an angle to the axial direction of the second rotating shaft 61, that is, the temple 2 rotates relative to the rotating base 3 and the frame 1 via the first connecting member 4 about the axial direction of the first rotating shaft 44; and the temple 2 rotates relative to the frame 1 via the rotating base 3 about the axial direction of the second rotating shaft 61, the temple 2 can rotate with multiple degrees of freedom relative to the frame 1 in multiple axial directions. This allows the glasses 100 to be suitable for users with different head lengths, head shapes, and nose-ear distances, improving user comfort and versatility.

In this embodiment, by housing one end of the first elastic member 5 within the receiving groove 31 and providing a damping groove 521 on the first elastic member 5 that rotatably abuts against the first rotating shaft 44, and by elastically abutting the other end of the first elastic member 5 against the first connecting member 4, the temple 2 rotates relative to the rotating base 3 and the frame 1 via the first connecting member 4 about the axial direction of the first rotating shaft 44. This creates frictional damping during rotation using the first elastic member 5, resulting in a damped folding hinge movement, thus achieving folding of the temple 2 and providing a folding damping feel while also providing an outward clamping force. Simultaneously, by placing the second elastic member 7 within the frame 1 and elastically abutting against the rotating base 3, the second elastic member 7 provides resistance to deformation and prevents over-bending failure during rotation of the temple 2 relative to the frame 1 via the rotating base 3 about the axial direction of the second rotating shaft 61.

The glasses 100 of the present application, by providing an installation groove 11 and a first through hole 13 and a second through hole 14 communicating with the installation groove 11 on the frame 1, facilitates the use of the installation groove 11 to conveniently accommodate and limit the rotating base 3 of the hinge structure. The rotating base 3 is provided with a receiving groove 31 and a first rotating hole 331, a second rotating hole 321 and a sliding hole 322 communicating with the receiving groove 31, such that the second rotating hole 321 corresponds to the first through hole 13 and the sliding hole 322 corresponds to the second through hole 14. In this way, one end of the first connecting member 4 of the hinge structure is rotatably connected to the rotating base 3 through the first rotating shaft 44 matching with the hole shaft of the first rotating hole 331, and the other end of the first connecting member 4 is connected to the temple 2. The second rotating shaft 62 of the second connecting member 6 of a hinge structure, is rotatably inserted through the first through hole 23 and the second rotating hole 321. The sliding shaft 62 is movably inserted through the second through hole 24 and the sliding hole 322. Thus, the temple 2 and frame 1 of the glasses 100 are rotatably connected through the first connecting member 4, the rotating base 3, and the second connecting member 6 of the hinge structure. The axial direction of the first rotating shaft 44 is set at an angle to the axial direction of the second rotating shaft 61. This allows the temple 2 to rotate relative to the rotating base 3 and the frame 1 via the first connecting member 4 about the first rotating shaft 44. Simultaneously, the temple 2 can also rotate relative to the frame 1 via the rotating base 3 about the second rotating shaft 61. That is, the temple 2 and the frame 1 can achieve multi-degree-of-freedom rotational hinge through the multi shaft rotation of the hinge structure, making the glasses 100 suitable for different head shapes of different users, such as users with different head lengths, different head shapes, and different nose-ear distances, thereby improving the user's wearing comfort and versatility. Furthermore, by placing one end of the first elastic member 5 within the receiving groove 31, and by providing the first elastic member 5 with a damping groove 521 that rotatably abuts against the first rotating shaft 44, so that the other end of the first elastic member 5 elastically abuts against the first connecting member 4. Thus, when the temple 1 rotates relative to the rotating base 3 and the frame 1 via the first connecting member 4 about the first rotating shaft 44, the first elastic member 5 provides damping performance for the rotation of the temple 2. The second elastic member 7 is provided within the frame 1 and elastically abuts against the rotating base 3. Thus, the second elastic member 7 provides elastic limiting and damping functions for the rotation of the rotating base 3 relative to the frame 1, thereby providing different rotation angles.

In this embodiment, the axial direction of the first rotating shaft 44 and the axial direction of the second rotating shaft 61 can optionally be perpendicular. Understandably, when a user wears glasses 100, and with the user's eyes as the light-emitting direction as a reference, the light-emitting direction, the axial direction of the first rotating shaft 44, and the axial direction of the second rotating shaft 61 are roughly perpendicular to each other in a three-dimensional coordinate structure. That is, the axial direction of the first rotating shaft 44 is roughly perpendicular to the light-emitting direction, and the axial direction of the second rotating shaft 61 is roughly perpendicular to the light-emitting direction.

It should be noted that, as shown in FIG. 8, glasses 100 has three states: a folded state, an open state, and an outward-folding state, where the temples 2 rotate relative to the rotating base 3 and the frame 1 via the first connecting member 4 around the first rotating shaft 44. Understandably, in the folded state, the temples 2 are close to the frame 1, meaning the temples 2 are roughly parallel to the frame 1, thus facilitating storage of glasses 100 in the folded state. When the glasses 100 are in the open state, the two temples 2 are roughly perpendicular to the frame 1. At this time, the two temples 2 and the frame 1 roughly enclose a U-shaped wearing cavity, facilitating contact between the two temples 2 and the user's ears. The nose pads of the frame 1 also contact the user's nose bridge, thus achieving a comfortable fit. When the glasses 100 are in the outward-folding position, the two temples 2 are roughly at an obtuse angle to the frame 1. At this time, the two temples 2 and the frame 1 roughly enclose a widened U-shaped wearing cavity. The two temples 2 contact the user's ears and the nose pads of the frame 1, thus achieving a comfortable fit. In other words, the outward-folding position is suitable for users with wider heads, while the open position is suitable for users with narrower heads.

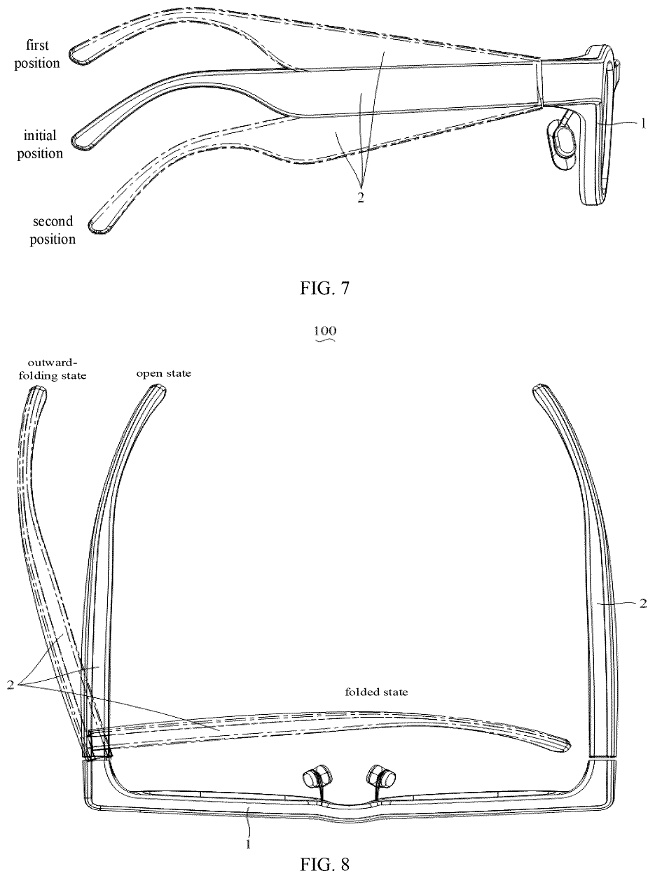

Meanwhile, as shown in FIG. 7, the glasses 100 have an initial position, a first position, and a second position for the temple 2 to rotate relative to the frame 1 via a rotating base 3 about a second rotating shaft 61. In this embodiment, the rotation of the temple 2 relative to the frame 1 about the second rotating shaft 61 can optionally occur when the glasses 100 is in an open state and an outward-folding state. That is, when the glasses 100 is in an open state and an outward-folding state, the temple 2 can rotate relative to the frame 1 about the second rotating shaft 61 in the initial position, the first position, and the second position, thus accommodating users with different head lengths and different nose-to-ear distances.

It should be noted that when the glasses 100 is in the open state, in the initial position, the extension direction of the temple 2 is consistent with the extension direction of the connecting portion or installation portion of the frame 1; in the first or second position, the extension direction of the temple 2 forms a certain angle with the extension direction of the connecting portion or installation portion of the frame 1. In an embodiment, the angle formed by the extension direction of the temple 2 and the extension direction of the connecting portion or installation portion of the frame 1 is an acute angle.

Understandably, taking the plane containing the light-emitting directions of the user's two eyes when wearing glasses 100 as the horizontal plane, with glasses 100 in the open and outward-folding states, in the first position, the end of the temple 2 far away from the frame 1 is above this horizontal plane, and the angle formed by the extension direction of the temple 2 and the horizontal plane is acute; in the second position, the end of the temple 2 far away from the frame 1 is below this horizontal plane, and the angle formed by the extension direction of the temple 2 and the horizontal plane is acute.

In an embodiment, the second elastic member 7 is provided with multiple stop grooves 711, and the outer wall of the rotating base 3 has a stop protrusion 332 corresponding to the stop groove 711, the stop protrusion 332 being movably limited within one stop groove 711.

In this embodiment, as shown in FIGS. 5, 6, 9, and 14, a stop groove 711 is provided on the second elastic member 7, and a stop protrusion 332 is provided on the rotating base 3. The stop protrusion 332 is movably limited within one stop groove 711. Thus, during the rotation of the temple 2 relative to the frame 1 via the rotating base 3 about the second rotating shaft 61, the stop protrusion 332 of the rotating base 3 can move from one stop groove 711 to another, thereby limiting the rotation of the temple 2 around the second rotating shaft 61 and preventing over-bending failure.

It is understood that the stop grooves 711 may include two, three, four, five, or more, etc., and are not limited here. Multiple stop grooves 711 are arranged adjacent to each other. In this embodiment, each stop groove 711 of the second elastic member 7 can correspond to different angles of rotation of the temple 2 around the second rotating shaft 61.

In an embodiment, the plurality of stop grooves 711 include a first stop groove 712, a second stop groove 713, and a third stop groove 714 arranged sequentially and adjacently.

In this embodiment, as shown in FIGS. 5, 6, and 14, the first stop groove 712, the second stop groove 713, and the third stop groove 714 are arranged sequentially along a vertical direction. The planes on which the openings of the first stop groove 712, the second stop groove 713, and the third stop groove 714 are located may be located on the same vertical plane. Of course, in other embodiments, the first stop groove 712, the second stop groove 713, and the third stop groove 714 may also be located on an arc-shaped surface, which is not limited here.

Understandably, the glasses 100 have an initial position, a first position, and a second position where the rotating base 3 drives the first connecting member 4 and the temple 2 to rotate relative to the frame 1 around the second rotating shaft 61. In the initial position, the stop protrusion 332 passes through the installation opening 12 and is limited within the second stop groove 713. In the first position, the stop protrusion 332 passes through the installation opening 12 and is limited within the first stop groove 712. In the second position, the stop protrusion 332 passes through the installation opening 12 and is limited within the third stop groove 714.

It should be noted that when the glasses 100 is in the open or outward-folding state, the temple 2 of the glasses 100 has an initial position, a first position, and a second position where the rotating base 3 drives the first connecting member 4 and the temple 2 to rotate relative to the frame 1 around the second rotating shaft 61. When the temple 2 is in the initial position, the stop protrusion 332 of the rotating base 3 is limited within the second stop groove 713. When the temple 2 rotates relative to the frame 1 around the second rotating shaft 61 from the initial position to the first position, the stop protrusion 332 of the rotating base 3 moves from the second stop groove 713 to the first stop groove 712. That is, when the temple 2 is in the first position, the stop protrusion 332 is limited within the first stop groove 712. When the temple 2 rotates relative to the frame 1 around the second rotating shaft 61 from the initial position to the second position, the stop protrusion 332 of the rotating base 3 moves from the second stop groove 713 to the third stop groove 714. That is, when the temple 2 is in the second position, the stop protrusion 332 is limited within the third stop groove 714.

It can be understood, as shown in FIG. 7, in the first position, the temple 2 is above the initial position, and in the second position, the temple 2 is below the initial position.

In an embodiment, the second elastic member 7 includes a stop portion 71 and two fixing portions 72 connected to both ends of the stop portion 71. The stop portion 71 has multiple stop grooves 711, and the side wall of the installation groove 11 has an installation opening 12. The two fixing portions 72 are connected to the outer side wall of the installation groove 11 so that the stop portion 71 corresponds to the installation opening 12, and the stop protrusion 332 passes through the installation opening 12 and is movably limited within a stop groove 711.

In this embodiment, as shown in FIGS. 2, 5, 6, 9, and 14, by setting the second elastic member 7 as a stop portion 71 and two fixing portions 72 connected to both ends of the stop portion 71, it is convenient to use the two fixing portions 72 of the second elastic member 7 to connect to the outer side wall of the installation groove 11 to achieve the installation and fixation of the second elastic member 7. The stop portion 71 is provided with multiple stop grooves 711, and an installation opening 12 is provided on the side wall of the installation groove 11, so that the stop portion 71 corresponds to the installation opening 12. This allows the stop protrusion 332 to easily pass through the installation opening 12 and move within a stop groove 711.

It is understood that the material of the second elastic member 7 can be a metal material, such as stainless steel, including materials such as titanium alloy, nickel-titanium alloy, and beryllium copper; or, the material of the second elastic member 7 can also be a non-metallic material, such as elastic plastic or carbon fiber, etc., without limitation. In this embodiment, when the stop protrusion 332 moves from one stop groove 711 to another stop groove 711 of the second elastic member 7, the stop portion 71 of the second elastic member 7 undergoes elastic deformation under the pressure of the stop protrusion 332.

In an embodiment, the two fixing portions 72 extend in opposite directions. In this embodiment, as shown in FIGS. 5, 6, 9, and 14, the two fixing portions 72 can be optionally located in the same plane. Of course, in other embodiments, the two fixing portions 72 may also be arranged in parallel, but not on the same plane, and this is not limited here.

In an embodiment, the two fixing portions 72 extend toward the same side of the stop portion 71. It is understood that the two fixing portions 72 and the stop portion 71 enclose a U-shaped structure, and this is not limited here.

It is understood that the stop portion 71 is located between the two fixing portions 72, and a groove structure is formed corresponding to the stop protrusion 332. In an embodiment, the stop groove 711 is provided on the bottom wall of the groove formed by the recess of the stop portion 71. In this embodiment, each fixing portion 72 is connected to the outer wall of the installation groove 11 by a fastener, which improves the connection stability of the second elastic member 7. The fixing portion 72 is provided with a screw hole, and the frame 1 is provided with a threaded hole, through which a screw or pin passes and is placed in the threaded hole, and this is not limited here.

In an embodiment, the first elastic member 5 includes a main body 51 and a damping arm 52. One end of the main body 51 is accommodated in a receiving groove 31, and the other end of the main body 51 forms an outward-folding spring piece 511, which elastically abuts against the first connecting member 4. The main body 51 also has an elastic through hole 512. One end of the damping arm 52 is connected to the inner wall of the elastic through hole 512, and the other end of the damping arm 52 extends along the elastic through hole 512 and is bent to form a damping groove 521.

In this embodiment, the first elastic member 5 can be a spring piece or an elastic plate structure. The material of the first elastic member 5 can be stainless steel or carbon fiber. In an embodiment, when the material of the first elastic member 5 is stainless steel, the stainless steel material includes one of titanium alloy, nickel-titanium alloy, and beryllium copper. Understandably, by providing an elastic through hole 512 in the main body 51 of the first elastic member 5, one end of the damping arm 52 connects to the inner wall of the elastic through hole 512, and the other end of the damping arm 52 extends along the elastic through hole 512 and bends to form a damping groove 521, thus improving the elastic performance of the damping arm 52.

Understandably, the main body 51 and the damping arm 52 of the first elastic member 5 are integrally formed, thus improving the connection stability and structural strength between the damping arm 52 and the main body 51. In this embodiment, the inner wall of the damping groove 521 abuts against the outer wall of the first rotating shaft 44, thus generating frictional damping when the first rotating shaft 44 rotates relative to the damping groove 521, giving the first rotating shaft 44 a folding damping feel during movement, thereby achieving the folding of the temple 2 and providing a folding damping feel.

In an embodiment, the distance from the end of the damping arm 52 bent to form the damping groove 521 to the damping arm 52 is defined as the opening width of the damping groove 521, and the opening width is less than or equal to ⅓ of the circumference of the first rotating shaft 44. It is understood that by setting the damping groove 521 of the damping arm 52 as a semi-open structure; that is, the damping groove 521 partially wraps around the outer wall of the first rotating shaft 44, it is convenient to install the first rotating shaft 44, and it also ensures that the damping groove 521 has good damping effect and damping feel.

It is understood that the cross-section of the first rotating shaft 44 in the direction perpendicular to the axial direction of the first rotating shaft 44 can optionally be circular, and the cross-section of the damping groove 521 in the direction perpendicular to the axial direction of the first rotating shaft 44 can optionally be arc-shaped. The circumference of the arc-shaped inner wall of the damping groove is greater than or equal to ⅔ of the circumference of the first rotating shaft 44.

In this embodiment, an outward-folding spring piece 511 is formed at one end of the main body 51. The outward-folding spring piece 511 elastically abuts against the first connecting member 4. Thus, when the glasses 100 is in the outward-folding state, when the temple 2 drives the first connecting member 4 to rotate outward relative to the frame 1 around the first rotating shaft 44, the first connecting member 4 drives the outward-folding spring piece 511 of the first elastic member 5 to elastically deform, thereby generating a torque for the first connecting member 4 to rotate inward, thereby providing a holding force. When the outward-folding force is removed, the elastically deformed outward-folding spring piece 511 will push the first connecting member 4 to drive the temple 2 back to the original state of the outward-folding spring piece 511, thereby realizing that the temple 2 can automatically spring back to the original position after the outward-folding force is removed.

Understandably, the first elastic member 5 can be selected as a spring piece structure, which has good elasticity. In an embodiment, the elastic modulus of the first elastic member 5 is 50 GPa to 400 GPa, that is, the elastic modulus of the first elastic member 5 is 50 GPa, 100 GPa, 150 GPa, 200 GPa, 250 GPa, 300 GPa, 350 GPa, 400 GPa, etc., which is not limited here.

To facilitate the use of the outward-folding spring piece 511 to provide clamping force when the first connecting member 4 is folded outward and to automatically rebound after the outward-folding force is removed, in this embodiment, the length of the outward-folding spring piece 511 can be selected to be 5 mm to 30 mm. In an embodiment, the length of the outward-folding spring piece 511 is 5 mm, 10 mm, 15 mm, 20 mm, 25 mm, 30 mm, etc., which is not limited here. In an embodiment, the thickness of the outward-folding spring piece 511 is 0.3 mm to 1.5 mm, that is, the thickness of the outward-folding spring piece 511 can be 0.3 mm, 0.5 mm, 0.8 mm, 1 mm, 1.3 mm, 1.5 mm, etc., and is not limited here. Understandably, this arrangement ensures that the first elastic member 5 has good elasticity.

In an embodiment, a fixing post 323 protrudes from the bottom wall of the receiving groove 31. The fixing post 323 is located between the first rotating hole 331 and the second rotating hole 321, and the main body 51 is fixed to the fixing post 323 by fasteners.

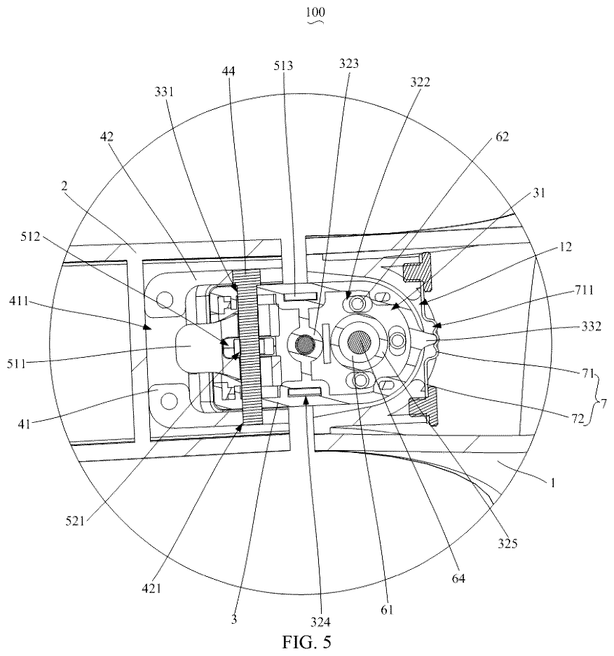

In this embodiment, as shown in FIGS. 4 to 6, 9, and 11, a fixing post 323 is provided within the receiving groove 31 of the rotating base 3, and a through hole is provided on the first elastic member 5 corresponding to the fixing post 323. Fasteners are then threaded or inserted through the through holes to the fixing post 323, thus fixing the first elastic member 5 to the rotating base 3. Simultaneously, the fixing post 323 provides support for the first elastic member 5. In an embodiment, the fixing post 323 is located between the first rotating hole 331 and the second rotating hole 321.

It is understood that the fixing post 323 may optionally be a threaded post, and the fastener may be a screw or pin, etc.

In an embodiment, one of the groove wall of the receiving groove 31 and the main body 51 has a locking protrusion 513, and the other has a locking groove 324. The locking protrusion 513 is limited within the locking groove 324.

In this embodiment, as shown in FIGS. 5, 6, 9, 11, and 13, a locking protrusion 513 and a locking groove 324 are provided in one of the rotating base 3 and the first elastic member 5, respectively. The locking protrusion 513 is limited within the locking groove 324, thereby further achieving the positioning, installation, and locking limitation of the first elastic member 5. It can be understood that the locking protrusion 513 is provided in the first elastic member 5, and the locking groove 324 is provided in the rotating base 3. Thus, with the locking protrusion 513 limited within the locking groove 324, both positioning and locking can be achieved, and the main body 51 of the first elastic member 5 can be supported by the locking protrusion 513 to ensure the deformation capability of the first elastic member 5.

In an embodiment, the rotating base 3 includes a base plate 32 and a side plate 33. The side plate 33 is provided around the periphery of the base plate 32 and forms a receiving groove 31 with the base plate 32. The side plate 33 has a first rotating hole 331, and the base plate 32 has a second rotating hole 321 and a sliding hole 322. The side plate 33 has a clearance notch 333 adjacent to the first rotating hole 331, communicating with the receiving groove 31. One end of the first elastic member 5, away from the second rotating hole 321, passes through the clearance notch 333 and elastically abuts against the first connecting member 4. A stop protrusion 332 also protrudes from the side of the side plate 33 facing away from the receiving groove 31. The stop protrusion 332 is located at the end of the side plate 33 away from the clearance notch 333 and elastically abuts against the second elastic member 7.

In this embodiment, as shown in FIGS. 4 to 6 and 9 to 11, the side plate 33 of the rotating base 3 surrounds the periphery of the base plate 32. The side plate 33 is optionally perpendicular to the base plate 32, thus enclosing to form a receiving groove 31. In an embodiment, the base plate 32 is rectangular or elongated. A clearance notch 333 is provided at one end of the side plate 33 adjacent to the base plate 32, facilitating clearance and limiting space for the first elastic member 5. One end of the first elastic member 5 passes through the clearance notch 333 and elastically abuts against the first connecting member 4. A stop protrusion 332 protrudes from the other end of the side plate 33 adjacent to the base plate 32, facing away from the receiving groove 31. The stop protrusion 332 and the clearance notch 333 are optionally located at both ends of the base plate 32.

Understandably, the side plate 33 also has a first rotating hole 331, located at one end of the side plate 33 adjacent to the clearance notch 333. In an embodiment, the axial direction of the second rotating hole 321 is perpendicular to the axial direction of the first rotating hole 331. This makes the axial direction of the first rotating shaft 44 perpendicular to the axial direction of the second rotating shaft 61.

In this embodiment, to prevent the second rotating shaft 61 from affecting the first connecting member 4 in rotating the temple 2 around the first rotating shaft 44, the base plate 32 has a second rotating hole 321 and a sliding hole 322 spaced apart, with the second rotating hole 321 located at the end of the base plate 32 away from the clearance notch 333. Understandably, one end of the rotating base 3 is accommodated in the installation groove 11 of the frame 1, and the other end of the rotating base 3 is rotatably connected to the first connecting member 4.

To ensure that the rotating base 3 can rotate relative to the frame 1 around the second rotating shaft 61, in an embodiment, a rotating cylinder 325 protrudes from the bottom wall of the receiving groove 31 around the second rotating hole 321. The second rotating shaft 61 rotatably passes through the first through hole 13 and the second rotating hole 321, and rotatably abuts against the inner wall of the rotating cylinder 325.

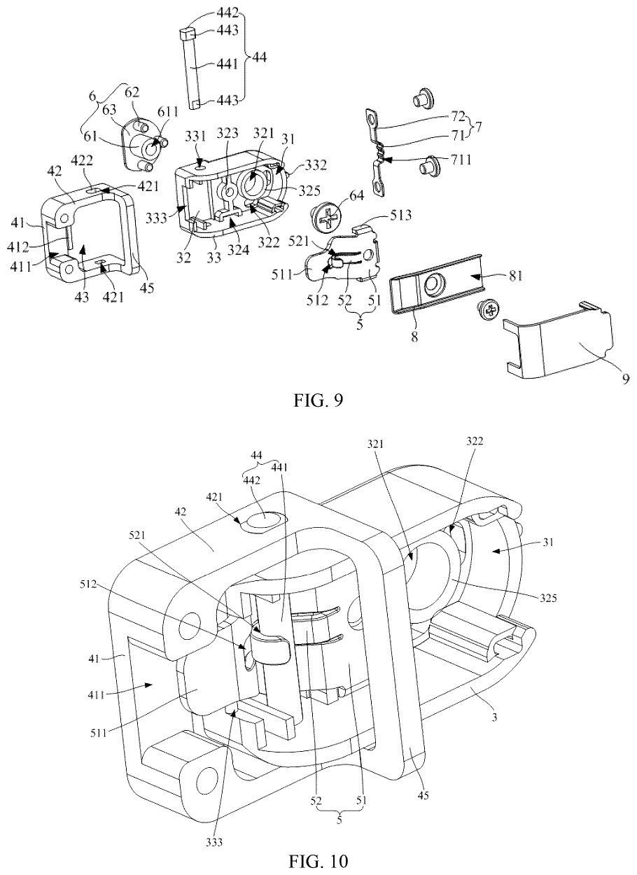

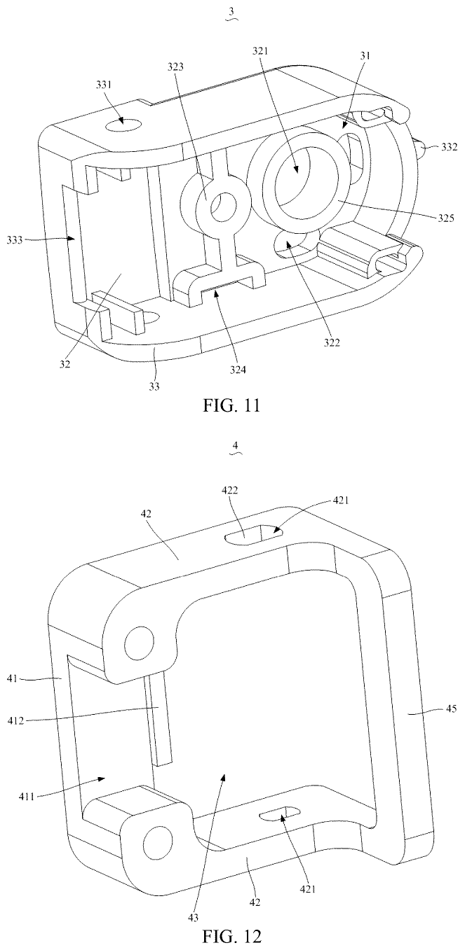

As can be understood, as shown in FIGS. 9 and 11, by protruding the rotating cylinder 325 on the base plate 32 of the rotating base 3, the rotating cylinder 325 is arranged around the second rotating hole 321. Thus, the second rotating shaft 61 rotatably passes through the first through hole 13 and the second rotating hole 321, and rotatably abuts against the inner wall of the rotating cylinder 325, thereby providing rotational and limiting space for the second rotating shaft 61 by the rotating cylinder 325.

In an embodiment, multiple sliding holes 322 are spaced apart around the second rotating hole 321. Multiple second through holes 14 are spaced apart around the first through hole 13. Each sliding hole 322 corresponds to one of the second through holes 14. A second connecting member 6 protrudes with multiple sliding shafts 62, which are spaced apart around the second rotating shaft 61. Each sliding shaft 62 movably passes through a second through hole 14 and a sliding hole 322.

In this embodiment, as shown in FIGS. 5, 6, and 9, the number of sliding holes 322 is the same as the number of second through holes 14, and they are arranged in a one-to-one correspondence. The number of sliding shafts 62 is the same as the number of sliding holes 322 and second through holes 14, and they are arranged in a one-to-one correspondence. In an embodiment, the axial direction of the second rotating hole 321 is parallel to the axial direction of the sliding hole 322.

To facilitate the movement of the sliding shaft 62 along the sliding hole 322 when the rotating base 3 rotates around the second rotating shaft 61, optionally, the sliding hole 322 is arranged in an arc shape with the center of the second rotating hole 321 as the center. In this embodiment, as shown in FIGS. 5, 6, and 9, there are three sliding holes 322, three second through holes 14, and three sliding shafts 62, with the three sliding holes 322 spaced apart around the second rotating hole 321. In an embodiment, the line connecting the three sliding holes 322 is arranged in a semi-circular arc shape.

It is understood that, to facilitate the connection and fixation of the frame 1 and the rotating base 3 by the second connecting member 6, and to ensure that the rotating base 3 rotates around the second rotating shaft 61 within the installation groove 11, the first through hole 13 and the second through hole 14 provided on the bottom wall of the installation groove 11 of the frame 1 are both circular.

In an embodiment, the second connecting member 6 includes a connecting plate 63, a second rotating shaft 61 protruding from the connecting plate 63, and a sliding shaft 62. The second rotating shaft 61 has a fixing hole 611. The second connecting member 6 also includes a fixing member 64, one end of which forms a limiting platform 641. The second rotating shaft 61 is rotatably inserted into the first through hole 13 and the second rotating hole 321, so that the frame 1 is clamped between the connecting plate 63 and the rotating base 3. One end of the fixing member 64 is located in the fixing hole 611, so that the limiting platform 641 movably abuts against the rotating base 3.

In this embodiment, as shown in FIGS. 2 to 4 and FIG. 9, the connecting plate 63 of the second connecting member 6 is used to provide the second rotating shaft 61 and the sliding shaft 62. A fixing hole 611 is provided in the second rotating shaft 61. When the second rotating shaft 61 rotates sequentially through the first through hole 13 and the second rotating hole 321, and the sliding shaft 62 sequentially passes through the second through hole 14 and the sliding hole 322, a portion of the frame 1 is sandwiched between the connecting plate 63 and the rotating base 3. One end of the fixing member 64 is located in the fixing hole 611, allowing the limiting platform 641 to movably abut against the rotating base 3. This enables the installation and rotational connection of the second connecting member 6, the frame 1, and the rotating base 3.

It is understood that, to conceal the connecting plate 63 of the second connecting member 6, a groove is also provided on the frame 1 corresponding to the connecting plate 63 of the second connecting member 6. Thus, when the second connecting member 6 is connected to the frame 1, the connecting plate 63 is accommodated and limited within this groove. This is not a limitation in this context.

In an embodiment, there are two first rotating holes 331, which are coaxially arranged and located on opposite sides of the receiving groove 31. The first connecting member 4 includes a first connecting portion 41 and two rotating arms 42 located at both ends of the first connecting portion 41. The two rotating arms 42 and the first connecting portion 41 enclose each other to form a clearance groove 43. Each rotating arm 42 has an installation hole 421 at its end away from the first connecting portion 41. The first connecting portion 41 is connected to the temple 2. A first rotating shaft 44 is sequentially inserted into the installation hole 421, the first rotating hole 331, and the damping groove 521, and both ends of the first rotating shaft 44 are fixed in the two installation holes 421, so that part of the rotating base 3 is accommodated in the clearance groove 43. The end of the first elastic member 5 away from the second rotating hole 321 elastically abuts against the first connecting portion 41.

In this embodiment, as shown in FIGS. 5, 6, and FIGS. 9 to 11, the base plate 32 of the rotating base 3 is optionally rectangular. The side plates 33 of the rotating base 3 are parallel and oppositely arranged on the two long rotating shaft sides of the base plate 32. That is, each side plate 33 on the two long rotating shaft sides of the base plate 32 is provided with a first rotating hole 331, and the two first rotating holes 331 are coaxially arranged. In an embodiment, the line connecting the two first rotating holes 331 is perpendicular to the axial direction of the second rotating shaft 61.

As can be understood, as shown in FIGS. 9, 10, and 12, by configuring the first connecting member 4 as a first connecting portion 41 and two rotating arms 42 located at both ends of the first connecting portion 41, the two rotating arms 42 and the first connecting portion 41 enclose a U-shaped clearance groove 43. An installation hole 421 is provided at the end of the rotating arm 42 away from the first connecting portion 41. Thus, the first connecting portion 41 of the first connecting member 4 is connected to the temple 2; a rotating shaft 44 is sequentially inserted into the installation hole 421, the first rotating hole 331, and the damping groove 521; and both ends of the first rotating shaft 44 are fixed within the two installation holes 421, allowing part of the rotating base 3 to be accommodated in the clearance groove 43, thereby achieving a rotational connection between the first connecting member 4 and the rotating base 3. In an embodiment, the first connecting member 4 and the temple 2 can be connected and fixed by welding, bonding, or using screws, pins, etc.

In an embodiment, the first rotating shaft 44 includes a rotating shaft portion 441 and installation portions 442 connected to both ends of the rotating shaft portion 441. The rotating shaft portion 441 passes sequentially through a first rotating hole 331 and a damping groove 521. Each installation portion 442 is limited within an installation hole 421. The installation hole 421 has at least one installation surface 422, and the installation portion 442 has a limiting surface 443 that mates with the installation surface 422.

In this embodiment, as shown in FIGS. 9 to 12, by providing limiting surfaces 443 at both ends of the first rotating shaft 44 and an installation surface 422 within the installation hole 421, when the installation portion 442 of the first rotating shaft 44 is limited within the installation hole 421, the limiting surface 443 engages with the installation surface 422, thereby ensuring that the first connecting member 4 rotates synchronously with the first rotating shaft 44. That is, the first connecting member 4 drives the first rotating shaft 44 to rotate relative to the first rotating hole 331 and the damping groove 521.

Understandably, the cross-section of the rotating shaft portion 441 of the first rotating shaft 44 may optionally be circular. In an embodiment, the installation hole 421 is a polygonal hole, and the first first rotating hole 331 is a circular hole. In this embodiment, the first rotating shaft 44 is a pin with a different cross-section, and both ends of the first rotating shaft 44 are flat shafts used to fix it to the installation hole 421 of the first connecting member 4, for example, by interference fit, spot welding, or bonding. The first rotating shaft 44 and the first rotating hole 331 of the rotating base 3 are fitted with a rotatable cylindrical hole and post to form a rotation center for mutual rotation.

In an embodiment, as shown in FIGS. 9 to 11, the first connecting member 41 is recessed to form a relief groove 411 communicating with the clearance groove 43. A support platform 412 protrudes from the side of the relief groove 411 adjacent to the clearance groove 43. The end of the first elastic member 5 away from the second rotating hole 321 extends into the relief groove 411 and is elastically supported on the support platform 412.

Understandably, by providing a relief groove 411 in the first connecting portion 41 of the first connecting member 4, the relief groove 411 provides clearance space for the outward-folding spring piece 511 of the first elastic member 5, and also provides a limiting space for the outward-folding spring piece 511.

In an embodiment, the first connecting member 4 further includes a limiting portion 45. The two ends of the limiting portion 45 are respectively connected to the ends of the two rotating arms 42 away from the first connecting portion 41, and the limiting portion 45 is located on the side of the first elastic member 5 facing away from the receiving groove 31. The first elastic member 5 has an outward-folding spring piece 511 that elastically abuts against the first connecting portion 41.

In this embodiment, as shown in FIGS. 9 to 11, by providing a limiting portion 45 on the first connecting member 4, with the two ends of the limiting portion 45 respectively connected to the ends of the two rotating arms 42 away from the first connecting portion 41, the limiting portion 45 can achieve a limiting effect when the temple 2 rotates relative to the rotating base 3 via the first connecting member 4 about the first rotating shaft 44.

Understandably, the glasses 100 have three states: a folded state, an open state, and an outward-folding state, where the first connecting member 4 drives the temple 2 to rotate around the first rotating shaft 44 relative to the rotating base 3 and the frame 1. In the folded state, the temple 2 is close to the frame 1, and the first connecting portion 41 is away from the first elastic member 5, while the limiting portion 45 is close to the outward-folding spring piece 511. In the open state, the temple 2 is away from the frame 1 and perpendicular to the frame 1; the first connecting portion 41 abuts against the outward-folding spring piece 511, and the limiting portion 45 is away from the outward-folding spring piece 511. In the outward-folding state, the temple 2 is at an obtuse angle to the frame 1, and the first connecting portion 41 causes the outward-folding spring piece 511 to deform.

It should be noted that when the glasses 100 is in the folded state, the rotating arm 42 of the first connecting member 4 is approximately perpendicular to the base plate 32 of the rotating base 3, and at this time, the limiting portion 45 is close to the outward-folding spring piece 511. When the glasses 100 is in the open state, the limiting portion 45 is located on the side of the side plate 33 of the rotating base 3 away from the base plate 32. When the glasses 100 is in the outward-folding state, when the first connecting portion 41 of the first connecting member 4 causes the outward-folding spring piece 511 to deform to its maximum deformation, the limiting portion 45 abuts against the side plate 33 of the rotating base 3 to prevent excessive outward folding of the temples 2.

In an embodiment, the glasses 100 also includes a protective plate 8 and a housing 9. The protective plate 8 is accommodated in a receiving groove 31 and connected to the side of the first elastic member 5 facing away from the bottom wall of the receiving groove 31. A wire-passing groove 81 is provided on the side of the protective plate 8 facing away from the first elastic member 5. The housing 9 covers the opening of the receiving groove 31 and cooperates with the wire-passing groove 81 to form a wire-passing channel 91.

In this embodiment, as shown in FIGS. 2, 4, and 9, by providing the protective plate 8 and the housing 9, the protective plate 8 provides wiring or mounting space for the flexible circuit board of the optical system connecting the glasses 100. Understandably, the protective plate 8 is accommodated in the receiving groove 31, and the protective plate 8 and the first elastic member 5 are sequentially fixed to the fixing post 323 of the rotating base 3 using fasteners, thereby achieving the installation and fixation of the protective plate 8.

Understandably, by providing a wire-passing groove 81 on the side of the protective plate 8 facing away from the first elastic member 5, the wire-passing groove 81 can be conveniently used for wiring or flexible circuit board installation. In this embodiment, the housing 9 is provided to protect the cables or flexible circuit boards within the wire-passing groove 81, and also to improve the aesthetic appearance.

In an embodiment, the housing 9 is detachably installed over the opening of the receiving groove 31 and cooperates with the wire-passing groove 81 to form a wire-passing channel 91. Understandably, by using a detachable connection between the housing 9 and the rotating base 3, the housing 9 can be easily removed at any time, facilitating the installation of cables or flexible circuit boards within the wire-passing groove 81.

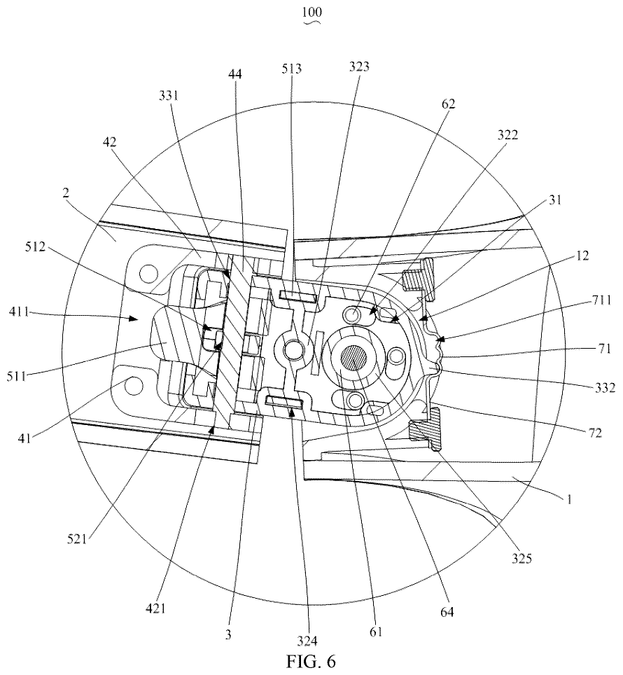

The glasses 100 of the present application mainly involve two degrees of freedom of rotation axes: a first rotating shaft 44 (rotating shaft A) as shown in FIG. 4, and a second rotating shaft 61 (rotating shaft B) as shown in FIGS. 5 and 6. rotating shaft A is used to realize the folding, unfolding, and outward-folding functions of the temples 2. It is understood that the folding function is used to fold and store the temples 2, and the outward-folding function is used to meet the comfort adjustment needs of users with different head widths. rotating shaft B is used to realize the lateral adjustment function of the temples 2, and rotating shaft B has three adjustment levels to meet the comfort adjustment needs of users with different head shapes and different nose-ear ratios.

It is understood that, as shown in FIG. 10, which is a schematic diagram of the hinge structure, the first connecting member 4, the rotating base 3, and the first elastic member 5 can be pre-assembled together as a whole module via the first rotating shaft 44. Then, the second connecting member 6, the second elastic member 7, the protective plate 8, and the housing 9 are assembled sequentially.

In this embodiment, the first connecting member 4, the rotating base 3, and the first elastic member 5 are assembled into a hinge module via the first rotating shaft 44. The first connecting member 4 is rigidly connected to the temple 2 via screws, adhesive, or other fixing methods. This hinge module is connected and fixed to the rotating base 3 of the hinge module via the second rotating shaft 61 of the second connecting member 6, which passes through the first through hole 13 on the frame 1. The second elastic member 7 is also fixed to the frame 1, so that the stop protrusion 332 of the rotating base 3 and the stop groove 711 of the second elastic member 7 cooperate to connect the hinge module to the frame 1. The hinge module is used to realize the rotating shaft A movement of the temple 2 and provide the outward rotation force. After the hinge module is assembled with the frame 1 via the cooperation of the second connecting member 6 and the second elastic member 7, it is used to realize the lateral movement of the temple 2 and provide the force (i.e., rotating shaft B). As shown in FIGS. 4 and 8, rotating shaft A is used to realize folding and outward rotation; as shown in FIGS. 5, 6, and 7, rotating shaft B is used to realize the lateral rotating shaft adjustment function of the temple 2.

Understandably, the temple 2 of the glasses 100 and the frame 1 are hinged together to achieve outward rotation and folding damping feel. When the temple 2 is rotated, the first connecting member 4 will rotate. The rotating base 3 is fixed to the frame 1. The first elastic member 5 is a metal plate with good elasticity. The outward-folding spring piece 511 on the first elastic member 5 is used to provide clamping force when folding outward and to automatically rebound after the outward-folding force is removed. The damping groove 521 of the damping arm 52 of the first elastic member 5 is used to provide damping force during the rotation of the temple 2, so that there is a certain damping feel during the movement. The first rotating shaft 44 is a pin with different cross sections, of which both ends are flat shafts, used to be rigidly fixed together with the first connecting member 4, for example, by interference fit, spot welding, bonding, etc. The first rotating shaft 44 and the rotating base 3 are fixed by a rotatable round hole cylindrical fit to form a rotating central shaft A for mutual rotation between the two. Therefore, when the temple 2 is folded, the temple 2 will drive the first connecting member 4 inward, and form a folding motion with the rotating base 3 through the first rotating shaft 44. The first rotating shaft 44 and the first connecting member 4 rotate together. The rotation of the first rotating shaft 44 will form frictional damping with the damping groove 521 of the first elastic member 5, so that the hinge movement has a folding damping feel during the movement, thereby realizing the folding of the temple 2 and making the folding have a damping feel.

When the temple 2 is turned outwards to accommodate users with different head widths, the temple 2 will cause the first connecting member 4 to rotate outwards. The rotating first connecting member 4 will cause the outward-turning spring 511 on the first elastic member 5 to elastically deform, thereby generating a torque that pushes the first connecting member 4 inwards, thus providing a supporting force. When the outward-turning force is removed, the elastically deformed outward-turning spring 511 will push the first connecting member 4 to return the temple 2 to its original state, thus achieving automatic return of the temple 2 to its original position after the outward-turning force is removed.

Understandably, the temple 2 and frame 1 of the glasses 100 can also achieve a side shaft adjustment structure to adjust the angle between the temple 2 and the frame 1, accommodating users with different head shapes. The second connecting member 6 extends from the inside of the frame 1, allowing the second rotating shaft 61 to pass through the corresponding first through hole 13 of the frame 1, then through the corresponding second rotating hole 321 on the rotating base 3, and finally be fixed by the fixing member 64. Since the three sliding shafts 62 of the second connecting member 6 are positioned with the corresponding second through holes 14 on the frame 1, and then fixed by the fixing member 64, the second connecting member 6 and the frame 1 are completely fixed; the rotating base 3 and the second connecting member 6 are matched with each other by a cylinder (second rotating shaft 61) and a round hole (second rotating hole 321). The second rotating hole 321 and the rotating cylinder 325 of the rotating base 3 and the second rotating shaft 61 of the second connecting member 6 form a center rotating shaft B, so that the hinge module can drive the temple 2 to rotate relative to the frame 1 and the second connecting member 6 along the center rotating shaft B. Because the stop protrusion 332 of the rotating base 3 and the stop groove 711 on the second elastic member 7 have corresponding position-limiting protrusions and grooves, the temple 2 can be positioned in either groove (i.e., the stop groove 711). When the temple 2 is rotated laterally, the stop protrusion 332 presses against the stop groove 711 of the second elastic member 7, causing elastic deformation. When the stop protrusion 332 rotates to the dividing line of the adjacent stop groove 711, the elastic deformation of the second elastic member 7 returns to normal, pushing the stop protrusion 332 to rotate into the adjacent stop groove 711, thus completing the angle adjustment between the temple 2 and the frame 1. The schematic diagrams after rotation are shown in FIGS. 5 and 6.

The sliding shaft 62 can slide within the corresponding sliding hole 322 on the rotating base 3, simultaneously enhancing the resistance to deformation when the temple 2 is twisted, and preventing over-bending failure. The second elastic member 7 can be flat, U-shaped, or other shapes. The material of the second elastic member 7 can be stainless steel, including materials such as titanium alloy, nickel-titanium alloy, and beryllium copper; or, the material of the second elastic member 7 can be composite materials such as carbon fiber. In an embodiment, the elastic modulus of the second elastic member 7 can be 50 GPa to 400 GPa. By adjusting the spacing and angle of the stop groove 711 on the second elastic member 7, the adjustment angle of the temple 2 can be changed within the range of 1 degree±30 degrees.

The present application also proposes an AR device, which includes an optical system and the aforementioned glasses 100. The optical system is connected to the frame 1 of the glasses 100. The specific structure of the glasses 100 is as described in the foregoing embodiments. Since this AR device adopts all the technical solutions of all the foregoing embodiments, it at least has all the beneficial effects brought about by the technical solutions of the foregoing embodiments, and will not be described in detail here.

In this embodiment, the AR device includes a flexible circuit board. One end of the flexible circuit board passes through the wire-passing channel 91 and is electrically connected to the optical system. It is understood that the temple 2 of the glasses 100 has a mounting cavity for installing a power supply, and the other end of the flexible circuit board is guided through the wire-passing channel 91 to the mounting cavity of the temple 2 for electrical connection with the power supply and other components; this is not limited here.

It is understood that the AR device can be virtual reality (VR), augmented reality (AR), mixed reality (MR), or extended reality (XR) glasses; this is not limited here.

Although some embodiments of the present application have been described, those skilled in the art, once they understand the basic inventive concept, can make other changes and modifications to these embodiments. Therefore, the appended claims are intended to be interpreted as including the embodiments as well as all changes and modifications falling within the scope of the present application.

The above descriptions are only some embodiments of the present application, and does not limit the patent scope of the present application. All equivalent structural transformations made by configuring the contents of the present application specification and drawings under the technical concept of the present application, or directly/indirectly applied in other related technical fields, are included in the patent protection scope of the present application.

What is claimed is:

1. Glasses, comprising:
a frame provided with an installation groove and a first through hole and a second through hole communicating with the installation groove;
temples; and
a hinge structure comprising a rotating base, a first connecting member, a first elastic member, a second connecting member, and a second elastic member;
wherein one end of the rotating base is movably accommodated in the installation groove, and the rotating base is provided with a receiving groove and a first rotating hole, a second rotating hole, and a sliding hole all communicating with the receiving groove;
the second rotating hole corresponds to the first through hole, and the sliding hole corresponds to the second through hole;
one end of the first connecting member is rotatably connected to the rotating base via a first rotating shaft engaging with a hole shaft of the first rotating hole, and the other end of the first connecting member is connected to the temple;
one end of the first elastic member is accommodated in the receiving groove and provided with a damping groove rotatably abutted against the first rotating shaft, and the other end of the first elastic member is elastically abutted against the first connecting member;
the second connecting member is provided with a second rotating shaft and a sliding shaft spaced apart;
the second rotating shaft rotatably passes through the first through hole and the second rotating hole sequentially, to make the rotating base rotatably connect to the frame;
the sliding shaft movably passes through the second through hole and the sliding hole;
the second elastic member is provided within the frame and elastically abutted against the rotating base; and
an axial direction of the first rotating shaft is at an angle to an axial direction of the second rotating shaft.

2. The glasses as claimed in claim 1, wherein the second elastic member is provided with multiple stop grooves, and an outer wall of the rotating base is provided with stop protrusions corresponding to the stop grooves; each stop protrusion is movably limited within each stop groove.

3. The glasses as claimed in claim 2, wherein the second elastic member comprises a stop portion and two fixing portions connected to both ends of the stop portion; the stop portion is provided with a plurality of stop grooves, and a side wall of the installation groove is provided with an installation opening; the two fixing portions are connected to an outer side wall of the installation groove to make the stop portion correspond to the installation opening; and the stop protrusion passes through the installation opening and is movably limited within one of the stop grooves.

4. The glasses as claimed in claim 3, wherein the two fixing portions extend in opposite direction; or
the two fixing portions extend in a same direction as the stop portion; and/or
each fixing portion is connected to the outer side wall of the installation groove by a fastener; and/or
the plurality of stop grooves comprise a first stop groove, a second stop groove, and a third stop groove arranged sequentially adjacent to each other; wherein, the glasses have an initial position, a first position, and a second position, in the positions the rotating base driving the first connecting member and the temple to rotate relative to the frame about the second rotating shaft; in the initial position, the stop protrusion passes through the installation opening and is located in the second stop groove; in the first position, the stop protrusion passes through the installation opening and is located in the first stop groove; in the second position, the stop protrusion passes through the installation opening and is located in the third stop groove.

5. The glasses as claimed in claim 1, wherein the first elastic member comprises a main body and a damping arm; one end of the main body is accommodated in the receiving groove, and the other end of the main body forms an outward-folding spring piece; the outward-folding spring piece is elastically abutted against the first connecting member, and the main body further comprises an elastic through hole; one end of the damping arm is connected to an inner wall of the elastic through hole, and the other end of the damping arm extends along the elastic through hole and bends to form the damping groove.

6. The glasses as claimed in claim 5, wherein the first elastic member is made of stainless steel or carbon fiber, and the stainless steel comprises one of titanium alloy, nickel-titanium alloy, and beryllium copper; and/or
an elastic modulus of the first elastic member is 50 GPa to 400 GPa; and/or
a length of the outward-folding spring piece is 5 mm to 30 mm; and/or
a thickness of the outward-folding spring piece is 0.3 mm to 1.5 mm; and/or
a distance from an end of the damping arm bent to form the damping groove to the damping arm is defined as an opening width of the damping groove, and the opening width is less than or equal to ⅓ of a circumference of the first rotating shaft; and/or
a fixing post protrudes from a bottom wall of the receiving groove; the fixing post is located between the first rotating hole and the second rotating hole, and the main body is fixed to the fixing post by fasteners; and/or
one of a groove wall of the receiving groove and the main body is provided with a locking protrusion, and the other one of the groove wall of the receiving groove and the main body is provided with a locking groove; the locking protrusion is limited within the locking groove.

7. The glasses as claimed in claim 1, wherein the rotating base comprises a base plate and a side plate; the side plate is provided around a periphery of the base plate and encloses with the base plate to form the receiving groove; the side plate is provided with the first rotating hole, and the base plate is provided with the second rotating hole and the sliding hole;
the side plate is provided with a clearance notch communicating with the receiving groove adjacent to the first rotating hole; one end of the first elastic member away from the second rotating hole passes through the clearance notch and is elastically abutted against the first connecting member, and one side of the side plate facing away from the receiving groove is further provided with a stop protrusion; the stop protrusion is located at an end of the side plate away from the clearance notch, and the stop protrusion is elastically abutted against the second elastic member.

8. The glasses as claimed in claim 1, wherein a rotating cylinder protrudes from a bottom wall of the receiving groove around the second rotating hole, and the second rotating shaft sequentially rotatably passes through the first through hole and the second rotating hole, and is rotatably abutted against an inner wall of the rotating cylinder; and/or
a plurality of sliding holes are spaced apart around the second rotating hole; a plurality of second through holes are spaced apart around the first through hole; the sliding hole and the second through hole are arranged in a one-to-one correspondence; the second connecting member protrudes with a plurality of sliding shafts, and the plurality of sliding shafts are spaced apart around the second rotating shaft; each sliding shaft movably passes through each second through hole and each sliding hole; and/or
an axial direction of the second rotating hole is perpendicular to an axial direction of the first rotating hole; and/or
the axial direction of the second rotating hole is parallel to an axial direction of the sliding hole; and/or
the sliding hole is arc-shaped with a center of the second rotating hole as the center of the sliding hole; and/or
the second connecting member comprises a connecting plate, and the second rotating shaft and the sliding shaft protruding from the connecting plate; the second rotating shaft is provided with a fixing hole, and the second connecting member further comprises a fixing member; one end of the fixing member forms a limiting platform, and the second rotating shaft rotates sequentially through the first through hole and the second rotating hole, so that the frame is clamped between the connecting plate and the rotating base; one end of the fixing member is located in the fixing hole, so that the limiting platform is movably abutted against the rotating base.

9. The glasses as claimed in claim 1, wherein two first rotating holes are provided, and the two first rotating holes are coaxially arranged and located on opposite sides of the receiving groove;
the first connecting member comprises a first connecting portion and two rotating arms provided at both ends of the first connecting portion, and the two rotating arms and the first connecting portion are enclosed to form a clearance groove; one end of each rotating arm away from the first connecting portion is provided with an installation hole, and the first connecting portion is connected to the temple; and
the first rotating shaft passes sequentially through the installation hole, the first rotating hole, and the damping groove, and both ends of the first rotating shaft are fixed in the two installation holes, so that a portion of the rotating base is accommodated in the clearance groove, and an end of the first elastic member away from the second rotating hole is elastically abutted against the first connecting portion.

10. The glasses as claimed in claim 9, wherein the first rotating shaft comprises a rotating shaft portion and installation portions connected to both ends of the rotating shaft portion, and the rotating shaft portion sequentially passes through the first rotating hole and the damping groove; each installation portion is limited within an installation hole; the installation hole has at least one installation plane, and the installation portion has a limiting plane cooperating with the installation plane; and/or
the installation hole is a polygonal hole, and the first rotating hole is a circular hole; and/or
the first connecting portion is recessed to form a relief groove communicating with the clearance groove, and a support platform protruding from one side of the relief groove adjacent to the clearance groove; one end of the first elastic member away from the second rotating hole extends into the relief groove and is elastically supported by the support platform.

11. The glasses as claimed in claim 9, wherein the first connecting member further comprises a limiting portion, and two ends of the limiting portion are respectively connected to the ends of the two rotating arms away from the first connecting portion; the limiting portion is located on a side of the first elastic member facing away from the receiving groove, and the first elastic member is provided with an outward-folding spring piece elastically abutted against the first connecting portion;
the glasses have: a folded state, an open state, and an outward-folding state; in the states, the first connecting member driving the temples to rotate relative to the rotating base and the frame around the first rotating shaft;
in the folded state, the temples are close to the frame; the first connecting portion is away from the first elastic member; and the limiting portion is close to the outward-folding spring piece;
in the open state, the temples are away from the frame and perpendicular to the frame; the first connecting portion is abutted against the outward-folding spring piece; and the limiting portion is away from the outward-folding spring piece; and
in the outward-folding state, the temples are at an obtuse angle to the frame; and the first connecting portion causes the outward-folding spring piece to deform.

12. The glasses as claimed in claim 1, wherein the glasses further comprise a protective plate and a housing; the protective plate is accommodated in the receiving groove and connected to a side of the first elastic member facing away from a bottom wall of the receiving groove; a side of the protective plate facing away from the first elastic member is provided with a wire-passing groove; the housing is provided to cover an opening of the receiving groove and cooperates with the wire-passing groove to form a wire-passing channel.

13. An augmented reality (AR) device, comprising: an optical system and the glasses as claimed in claim 1, the optical system being connected to the frame of the glasses.
